(19) United States
(12) Patent Application Publication
(10) Pub. No.: US 2012/0249128 A1
(43) Pub. Date: Oct. 4, 2012

(54) MAGNETIC SENSOR SYSTEM

(75) Inventors: Xinyu Zhou, Troy, MI (US); Christopher G. Benson, Rochester Hills, MI (US); Moussa Ndiaye, Canton, MI (US); Eric Thomas Carlson, Linden, MI (US); Philip C. Lundberg, Keego Harbor, MI (US); Qiang Niu, Novi, MI (US); Jesse B. Bradley, Royal Oak, MI (US)

(73) Assignee: GM GLOBAL TECHNOLOGY OPERATIONS LLC, Detroit, MI (US)

(21) Appl. No.: 13/404,495

(22) Filed: Feb. 24, 2012

Related U.S. Application Data
(60) Provisional application No. 61/468,465, filed on Mar. 28, 2011.

(51) Int. Cl. G01B 7/14

(52) U.S. Cl. 324/207.24

(57) ABSTRACT

A linear sensor system includes a first field sensor displaced linearly from a second field sensor. A member having high magnetic permeability is disposed between the first field sensor and the second field sensor. The member is optimized in shape and material to completely remove any redirection or interference of the magnetic flux in the field sensors. A torque transmitting device incorporating the linear sensor system is also disclosed.

### CROSS-REFERENCE TO RELATED APPLICATIONS

This application claims the benefit of U.S. Provisional Application No. 61/468,465, filed on Mar. 28, 2011, which is herein incorporated by reference in its entirety.

### FIELD

The present disclosure relates to magnetic sensor systems, and more particularly, to magnetic sensor systems that sense magnetic flux.

### BACKGROUND

The statements in this section merely provide background information related to the present disclosure and may or may not constitute prior art.

Transmissions and other powertrain components in automotive vehicles are complex mechanisms controlled by hydraulic systems and electronic control modules. In order to provide proper control, it is desirable to have feedback on the operating conditions and performance of the transmission as the transmission operates. For example, transmissions typically include a plurality of sensors that communicate information indicative of the operating state of the transmission to the electronic controller. These sensors take many forms and perform various functions. For example, it is often desirable to determine the engagement condition of a torque transmitting device, such as the clutches used in a dual clutch transmission. Accordingly, one or more linear displacement sensors are used to measure the relative position of the clutches in order to determine engagement state.

However, in certain environments, it is possible for the linear displacement sensor to have dead-band locations where the magnetic flux is redirected or interfered with due to other nearby components. While current linear displacement sensors are useful for their intended purpose, there is room in the art for an improved linear displacement sensor system that reduces or eliminates magnetic flux interference in magnetically difficult areas of a transmission.

### SUMMARY

A linear sensor system includes a first field sensor displaced linearly from a second field sensor. A member having high magnetic permeability is disposed between the first field sensor and the second field sensor. The member is optimized in shape and material to remove any redirection or interference of the magnetic flux in the field sensors.

In one form, a linear sensor system is provided that has a first field sensor and a second field sensor spaced apart from the first field sensor. The system further includes a flux conducting member having a magnetic permeability that is greater than or equal to the magnetic permeability of steel. The flux conducting member is disposed between the first field sensor and the second field sensor.

In another form, which may be combined with or separate from the other forms described herein, a linear sensor system is provided that includes a first permanent magnetic linear contactless displacement sensor having a first magnetic core surrounded by a first coil and a second permanent magnetic linear contactless displacement sensor having a second magnetic core surrounded by a second coil. A flux conducting member formed of either low carbon steel or mu-metal is disposed between the first and second sensors. The flux conducting member is axially aligned with the first magnetic core and with the second magnetic core. An insulative material surrounds the first and second field sensors and the flux conducting member, wherein the first and second field sensors and the flux conducting member are disposed within the insulative material.

In another form, which may be combined with or separate from the other forms described herein, a torque transmitting device for a transmission is provided. The torque transmitting device includes an input member, a driven shaft having a shaft magnetic permeability, a clutch assembly selectively connecting the input member to the driven shaft, and an activating member having a main body and a permanent magnet attached to the main body. The actuating member is configured to move in a linear direction to activate the clutch assembly to connect the input member to the driven shaft. The torque transmitting device further includes a sensor system. The sensor system has a first field sensor, a second field sensor spaced apart from the first field sensor, and a flux conducting member having a member magnetic permeability that is higher than the shaft magnetic permeability of the driven shaft. The flux conducting member is disposed between the first field sensor and the second field sensor. The sensor system is operable to sense a linear displacement of the activating member.

In another form, which may be combined with or separate from the other forms described herein, a linear sensor system is provided that includes a first field sensor, a second field sensor spaced apart from the first field sensor, and a flux conducting member having a magnetic permeability that is higher than the magnetic permeability of surrounding structures. The flux conducting member is disposed between the first field sensor and the second field sensor.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a cross section of a portion of an exemplary dual clutch transmission showing an exemplary dual clutch actuation system;

FIG. 2 is perspective view of a sensor housing used in the dual clutch actuation system;

FIG. 3 is a top view of a PLOD sensor according to the principles of the present invention;

FIG. 4 is a cross-section of the PLOD sensor shown in FIG. 3;

FIG. 5 is a cross-section the PLOD sensor of FIG. 3 having another variation of a flux conducting member, in accordance with the principles of the present invention;

FIG. 6 is a graph illustrating dead-band of an output of another sensor system; and

FIG. 7 is a graph illustrating an output curve of a sensor system with no dead-band, in accordance with the principles of the present invention.

### DETAILED DESCRIPTION

The following description is merely exemplary in nature and is not intended to limit the present disclosure, application, or uses.

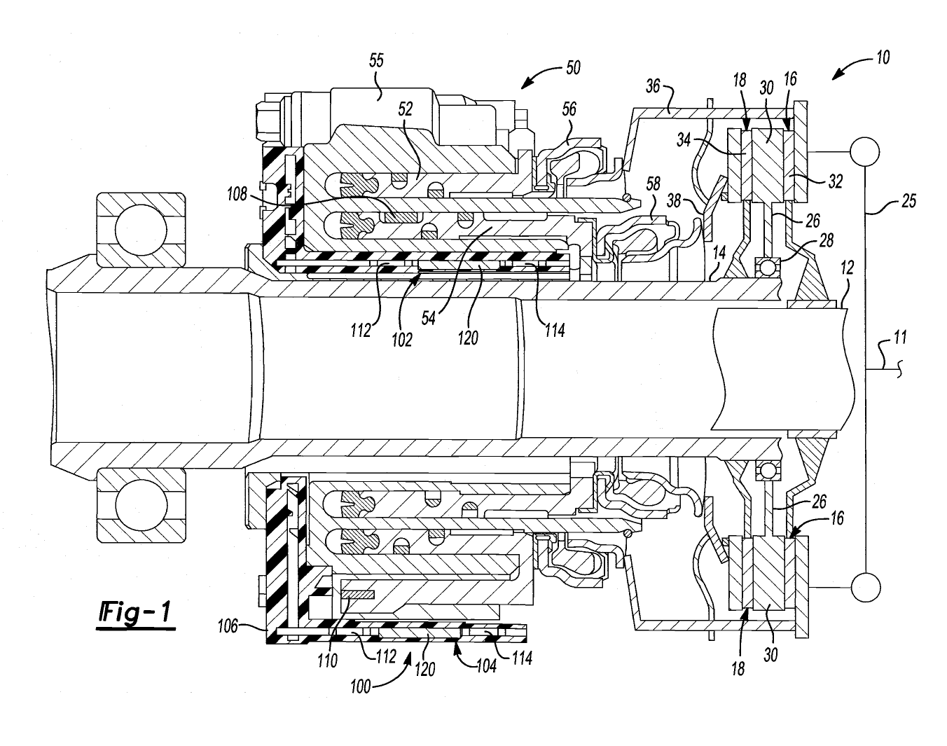

With reference to FIG. 1, a torque transmitting device for a dual input transmission (not shown) is generally indicated by reference number 10. The torque transmitting device 10 is for example a dual clutch disposed in a vehicle powertrain. Typically the vehicle powertrain includes an engine and a transmission. In the instant embodiment the transmission is a dual input transmission where torque is transferred from the engine via a crankshaft 11 to two input shafts in the transmission including a first input shaft 12 and a second input shaft 14 through selective operation of the torque transmitting device 10. The second input shaft 14 is a sleeve (or hollow) shaft that is concentric with and overlies the first input shaft 12. The torque transmitting device 10 is disposed in a transmission housing or bell housing (not shown).

The torque transmitting device 10 has two separate and independent friction clutches 16 and 18. The clutches 16 and 18 are rotationally fixed to a flywheel 25. The flywheel 25 is rotationally fixed to the crankshaft 11 and is preferably a dual mass flywheel that is configured to dampen and reduce vibration in the crankshaft 11.

The torque transmitting device 10 includes a central hub 30 rotationally connected with the outer hub. The central hub 30 is supported for rotation relative to the sleeve shaft 14 via a plurality of bearings 28. The central hub 30 includes a fixed friction plate that is fixed from movement in an axial direction.

The friction clutches 16 and 18 each include friction members 32 and 34, respectively. The friction member 32 is connected to the input shaft 12. The friction member 34 is connected to the sleeve shaft 14. The friction members 32, 34 are disposed on either side of the axially fixed friction plate of the central hub 30.

The friction clutches 16 and 18 are engaged with the friction plate of the central hub 30 through axially moveable apply members 36 and 38, respectively. The apply members 36 and 38 are each selectively translatable in an axial direction to engage one of the friction members 32 and 34 in order to couple the crankshaft 11 with one of the input shafts 12 and 14. The apply members 36 and 38 are selectively actuated by a lever actuation assembly 50.

The lever actuation assembly 50 includes a pair of annular pistons 52 and 54 disposed in a cylinder housing 55. The cylinder housing 55 is rotationally fixed relative to the transmission. A pair of annular bearing assemblies 56 and 58 are each connected with ends of the annular pistons 52 and 54, respectively. The annular pistons 52 and 54 are configured to translate within the cylinder housing 55 when actuated by hydraulic fluid. The annular pistons 52 and 54 and the annular bearings 56 and 58 are radially aligned such that the annular piston 52 and the annular bearing 56 are engageable with the apply member 36 to selectively engage the first clutch 16 and the annular piston 54 and annular bearing 58 are engageable with the apply member 38 to selectively engage the second clutch 18. The bearing assemblies 56 and 58 are actuation bearings that torsionally decouple the rotating elements of the dual clutch 10 (i.e. the first and second members 36 and 38) from the non-rotating members of the actuation device 50 (i.e. the pistons 52 and 54).

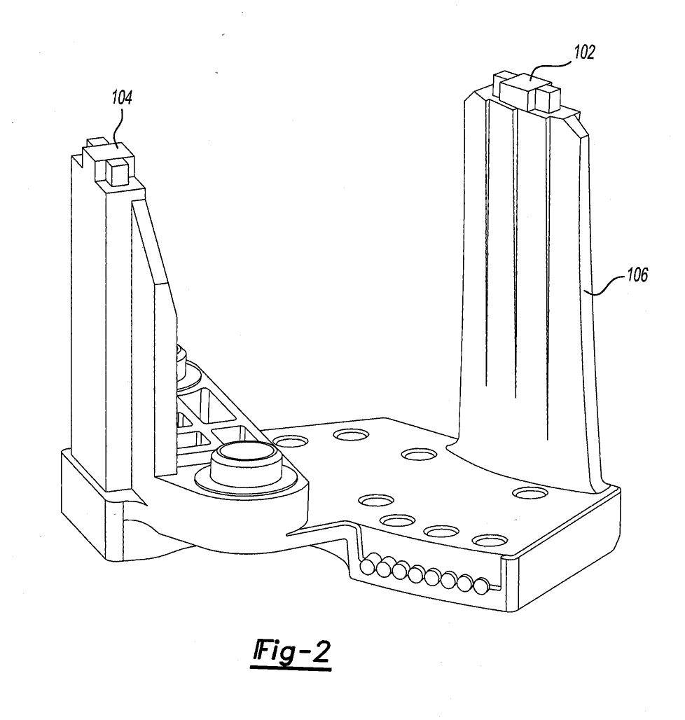

The torque transmitting device 10 further includes a clutch actuation sensor assembly 100 operable to sense the engagement of the clutches 16 and 18 by sensing the linear displacement of the pistons 52 and 54. The sensor assembly 100 includes an inner permanent magnetic linear contactless displacement (PLOD) sensor 102 and an outer PLOD sensor 104. The PLOD sensors 102, 104 are disposed within a sensor housing 106, best shown in FIG. 2. The sensor housing 106 is coupled to the cylinder housing 55 and is configured to position the PLOD sensors 102, 104 proximate an inner permanent magnet 108 and an outer permanent magnet 110, respectively. The inner magnet 108 is coupled to the annular piston 54 and the outer magnet 110 is coupled to the annular piston 52. The PLOD sensors 102, 104 are operable to detect a magnetic field induced by the magnetic flux of the magnets 108, 110 as they are displaced by translation of the annular pistons 52 and 54.

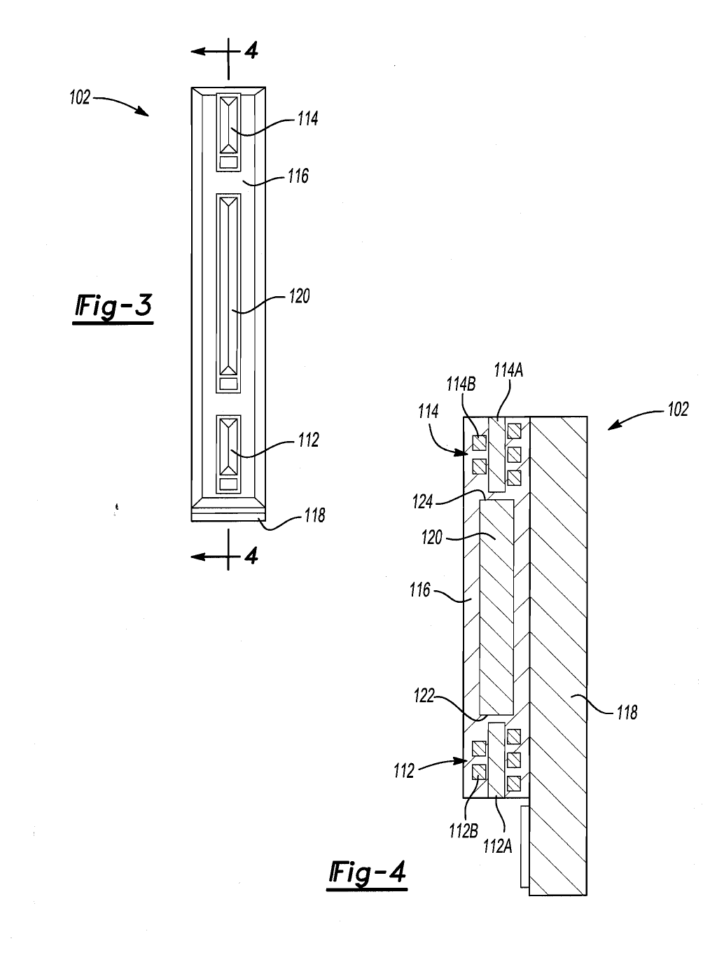

Turning to FIGS. 3 and 4, the PLOD sensors 102 and 104 will now be described. As both sensors are identical in this embodiment, reference will be made to the inner PLOD sensor 102 with the understanding that the description provided herein is applicable to the outer PLOD sensor 104. The PLOD sensor 102 includes a first field sensor 112 and a second field sensor 114. The first field sensor 112 includes a magnetic core 112A surrounded by a coil 112B. Likewise, the second field sensor 114 includes a magnetic core 114A surrounded by a coil 114B. Both field sensors 112 and 114 are supported in an insulative material 116 that is attached to a substrate or backing 118. The insulative material 116 could be a plastic, such as printed circuit board (PCB), by way of example.

The first field sensor 112 is spaced axially apart and away from the second field sensor 114. A flux conducting member 120 is disposed between the first and second field sensors 112, 114 within the insulative material 116. The member 120 is axially aligned with the magnetic cores 112A, 114A. The member 120 has a high magnetic permeability. The member 120 may have various shapes and sizes and be made from various materials without departing from the scope of the present invention. In the example provided, the member 120 is a rectangular steel bar. The member 120 is optimized to have equal to or higher magnetic permeability than any surrounding structures, including, for example, the sleeve shaft 14 which may be made from 5120 steel. The member 120 prevents the magnetic flux of the magnet 108 from being redirected by surrounding structures, thereby preventing weakening of the magnetic field detected in the first and second field sensors 112, 114 as the magnet 108 is translated by the movement of the annular piston 54. In some variations, the member 120 could be low carbon steel, mu-metal, or any other material having a magnetic permeability that is equal to or greater than the magnetic permeability of steel, by way of example. Mu-metal, as known, is a nickel-iron alloy, comprising mostly nickel, and also comprising iron, copper, and chromium or molybdenum.

In this embodiment, the cross section of the flux conducting member 120 has a generally rectangular shape, with a first end 122 that is located adjacent to the first field sensor 112 and a second end 124 that is located adjacent to the second field sensor 114. The flux conducting member 120 could have any other number of shapes without falling beyond the spirit and scope of the present disclosure; for example, the flux conducting member 120 could have a cylindrical shape or an irregular shape.

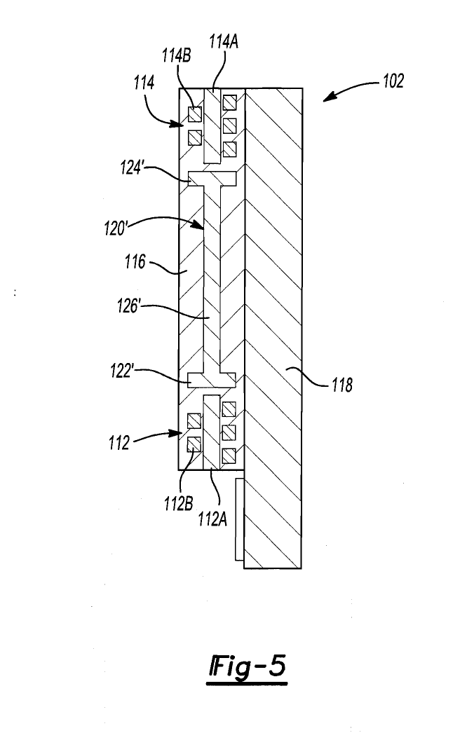

For example, referring to FIG. 5, another variation of the cross-section of the flux conducting member is illustrated and generally designated at 120′. In this variation, the cross section of the flux conducting member 120′ has the shape of long “H”. The flux conducting member 120′ has a first 122′ located adjacent to the first field sensor 112 and a second end 124′ located adjacent to the second field sensor 114. The first and second ends 122′, 124′ are wider than a thin body portion 126′ that connects the first and second ends 122′, 124′. The flux conducting member's 120′ H-shape cross-section resembles a rectangle that has portions cut away at its sides. In the alternative, the flux conducting member 120, 120′ could have any other suitable shape, without falling beyond the spirit and scope of the present disclosure. The rest of the sensor 102 illustrated in FIG. 5 remains the same as the sensor 102 as described in the other figures.

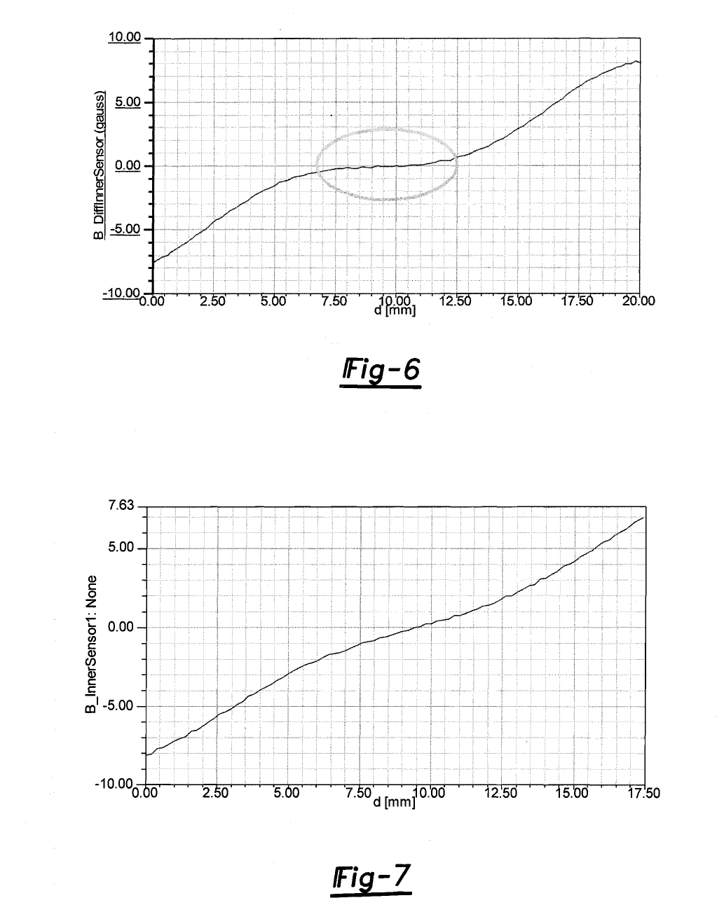

The member 120 specifically strengthens the magnetic field at the field sensor 112, 114 locations in the same direction as the effective magnetic flux that the field sensors 112, 114 are sensing. A design optimization is used to find the best size of the member 120 which completely removes any dead-band (i.e. no relationship between detected magnetic flux in the field sensors 112, 114 and linear placement of the magnet 108) in the sensor output. This dead-band is illustrated in the graph of FIG. 6.

The member 120 also improves the linearity of the PLOD sensor's output curve (of detected magnetic flux to distance stroked) over the entire stroke of the magnet 108, as shown in the graph of FIG. 7. Therefore the output of the PLOD sensor 102 is much more robust and able to resist the interference of any adjacent ferrous parts, has better linearity of detected current versus displacement, and has better signal to noise ratio.

The description of the invention is merely exemplary in nature and variations that do not depart from the gist of the invention are intended to be within the scope of the invention. Such variations are not to be regarded as a departure from the spirit and scope of the invention.

What is claimed is:

1. A linear sensor system comprising:
a first field sensor;
a second field sensor spaced apart from the first field sensor; and
a flux conducting member having a magnetic permeability that is greater than or equal to the magnetic permeability of steel, the flux conducting member being disposed between the first field sensor and the second field sensor.

2. The linear sensor system of claim 1, further comprising an insulative material surrounding the first and second field sensors and the flux conducting member, the first and second field sensors and the flux conducting member being disposed within the insulative material.

3. The linear sensor system of claim 2, the first and second field sensors being permanent magnetic linear contactless displacement sensors.

4. The linear sensor system of claim 3, the first field sensor having a first magnetic core surrounded by a first coil, and the second field sensor having a second magnetic core surrounded by a second coil.

5. The linear sensor system of claim 4, the flux conducting member being axially aligned with the first magnetic core and with the second magnetic core.

6. The linear sensor system of claim 5, wherein the flux conducting member is made of low carbon steel.

7. The linear sensor system of claim 5, wherein the flux conducting member has a higher magnetic permeability than 5120 steel.

8. The linear sensor system of claim 5, wherein the flux conducting member has a cross-section having two ends and a main body portion, each end being wider than the main body portion.

9. The linear sensor system of claim 1, further comprising a piston having a main body and a permanent magnet attached to the main body, the piston configured to move in a linear direction and result in a linear displacement of the piston, the first and second field sensors operable to sense the linear displacement of the piston, the linear sensor system further comprising a clutch assembly selectively engageable by the piston.

10. A linear sensor system comprising:
a first permanent magnetic linear contactless displacement sensor having a first magnetic core surrounded by a first coil;
a second permanent magnetic linear contactless displacement sensor having a second magnetic core surrounded by a second coil;
a flux conducting member formed of one of low carbon steel and mu-metal, the flux conducting member being disposed between the first and second sensors, the flux conducting member being axially aligned with the first magnetic core and with the second magnetic core; and
an insulative material surrounding the first and second field sensors and the flux conducting member, the first and second field sensors and the flux conducting member being disposed within the insulative material.

11. The linear sensor system of claim 10, further comprising a piston having a main body and a permanent magnet attached to the main body, the piston configured to move in a linear direction and result in a linear displacement of the piston, the first and second sensors operable to sense the linear displacement of the piston, the linear sensor system further comprising a clutch assembly selectively engageable by the piston.

12. A torque transmitting device for a transmission, the torque transmitting device comprising:
an input member;
a driven shaft having a shaft magnetic permeability;
a clutch assembly selectively connecting the input member to the driven shaft;
an activating member having a main body and a permanent magnet attached to the main body, the actuating member configured to move in a linear direction to activate the clutch assembly to connect the input member to the driven shaft; and
a sensor system comprising:
a first field sensor;
a second field sensor spaced apart from the first field sensor; and
a flux conducting member having a member magnetic permeability that is higher than the shaft magnetic permeability of the driven shaft, the flux conducting member being disposed between the first field sensor and the second field sensor,
wherein the sensor system is operable to sense a linear displacement of the activating member.

13. The torque transmitting device of claim 12, further comprising an insulative material surrounding the first and second field sensors and the flux conducting member, the first and second field sensors and the flux conducting member being disposed within the insulative material.

14. The torque transmitting device of claim 13, the first and second field sensors being permanent magnetic linear contactless displacement sensors.

15. The torque transmitting device of claim 14, the first field sensor having a first magnetic core surrounded by a first coil, and the second field sensor having a second magnetic core surrounded by a second coil.

16. The torque transmitting device of claim 15, the flux conducting member being axially aligned with the first magnetic core and with the second magnetic core.

17. The torque transmitting device of claim 16, wherein the flux conducting member is made of one of low carbon steel and mu-metal.

18. The torque transmitting device of claim 16, wherein the flux conducting member has a higher magnetic permeability than 5120 steel.

19. A linear sensor system comprising:
a first field sensor;
a second field sensor spaced apart from the first field sensor; and
a flux conducting member having a magnetic permeability that is higher than the magnetic permeability of surrounding structures, the flux conducting member being disposed between the first field sensor and the second field sensor.

20. The linear sensor system of claim 19 wherein the first and second field sensors are permanent magnetic linear contactless displacement sensors, each having a magnetic core surrounded by a coil, and wherein the flux conducting member is axially aligned with the magnetic cores, the linear sensor system further comprising an insulative material surrounding the first and second field sensors and the flux conducting member.
